SEQUENCE LISTING (14 sequences)

SEQ ID NO: 1 - DNA, 1434 bp, Aspergillus oryzae
  CDS (1)..(1434)
gcaacgcctgcggactggcgatcgcaatccatttatttccttctcacggatcgatttgcaaggacggatgggtcgacgactgcgacttgtaatactgcggatcagaaatactgtggtggaacatggcagggcatcatcgacaagttggactatatccagggaatgggcttcacagccatctggatcacccccgttacagcccagctgccccagaccaccgcatatggagatgcctaccatggctactggcagcaggatatatactctctgaacgaaaactacggcactgcagatgacttgaaggcgctctcttcggcccttcatgagagggggatgtatcttatggtcgatgtggttgctaaccatatgggctatgatggagcgggtagctcagtcgattacagtgtgtttaaaccgttcagttcccaagactacttccacccgttctgtttcattcaaaactatgaagatcagactcaggttgaggattgctggctaggagataacactgtctccttgcctgatctcgataccaccaaggatgtggtcaagaatgaatggtacgactgggtgggatcattggtatcgaactactccattgacggcctccgtatcgacacagtaaaacacgtccagaaggacttctggcccgggtacaacaaagccgcaggcgtgtactgtatcggcgaggtgctcgacggtgatccggcctacacttgtccctaccagaacgtcatggacggcgtactgaactatcccatttactatccactcctcaacgccttcaagtcaacctccggcagcatggacgacctctacaacatgatcaacaccgtcaaatccgactgtccagactcaacactcctgggcacattcgtcgagaaccacgacaacccacggttcgcttcttacaccaacgacatagccctcgccaagaacgtcgcagcattcatcatcctcaacgacggaatccccatcatctacgccggccaagaacagcactacgccggcggaaacgaccccgcgaaccgcgaagcaacctggctctcgggctacccgaccgacagcgagctgtacaagttaattgcctccgcgaacgcaatccggaactatgccattagcaaagatacaggattcgtgacctacaagaactggcccatctacaaagacgacacaacgatcgccatgcgcaagggcacagatgggtcgcagatcgtgactatcttgtccaacaagggtgcttcgggtgattcgtataccctctccttgagtggtgcgggttacacagccggccagcaattgacggaggtcattggctgcacgaccgtgacggttggttcggatggaaatgtgcctgttcctatggcaggtgggctacctagggtattgtatccgactgagaagttggcaggtagcaagatctgtagtagctcg

SEQ ID NO: 2 - protein, 478 aa, Aspergillus oryzae
ATPADWRSQSIYFLLTDRFARTDGSTTATCNTADQKYCGGTWQGIIDKLDYIQGMGFTAIWITPVTAQLPQTTAYGDAYHGYWQQDIYSLNENYGTADDLKALSSALHERGMYLMVDVVANHMGYDGAGSSVDYSVFKPFSSQDYFHPFCFIQNYEDQTQVEDCWLGDNTVSLPDLDTTKDVVKNEWYDWVGSLVSNYSIDGLRIDTVKHVQKDFWPGYNKAAGVYCIGEVLDGDPAYTCPYQNVMDGVLNYPIYYPLLNAFKSTSGSMDDLYNMINTVKSDCPDSTLLGTFVENHDNPRFASYTNDIALAKNVAAFIILNDGIPIIYAGQEQHYAGGNDPANREATWLSGYPTDSELYKLIASANAIRNYAISKDTGFVTYKNWPIYKDDTTIAMRKGTDGSQIVTILSNKGASGDSYTLSLSGAGYTAGQQLTEVIGCTTVTVGSDGNVPVPMAGGLPRVLYPTEKLAGSKICSSS

SEQ ID NO: 3 - DNA, 294 bp, Athelia rolfsii
  CDS (1)..(294)
gtcgaggtcactttcgacgtttacgctaccacagtatatggccagaacatctatatcaccggtgatgtgagtgagctcggcaactggacacccgccaatggtgttgcactctcttctgctaactaccccacctggagtgccacgatcgctctccccgctgacacgacaatccagtacaagtatgtcaacattgacggcagcaccgtcatctgggaggatgctatcagcaatcgcgagatcacgacgcccgccagcggcacatacaccgaaaaagacacttgggatgaatcttag

SEQ ID NO: 4 - protein, 97 aa, Athelia rolfsii
VEVTFDVYATTVYGQNIYITGDVSELGNWTPANGVALSSANYPTWSATIALPADTTIQYKYVNIDGSTVIWEDAISNREITTPASGTYTEKDTWDES

SEQ ID NO: 5 - DNA, 33 bp, Athelia rolfsii
  CDS (1)..(33)
ggtgctacaagcccgggtggctcctcgggtagt

SEQ ID NO: 6 - protein, 11 aa, Athelia rolfsii
GATSPGGSSGS

SEQ ID NO: 7 - DNA, 1761 bp, Aspergillus oryzae
  CDS (1)..(1761)
gcaacgcctgcggactggcgatcgcaatccatttatttccttctcacggatcgatttgcaaggacggatgggtcgacgactgcgacttgtaatactgcggatcagaaatactgtggtggaacatggcagggcatcatcgacaagttggactatatccagggaatgggcttcacagccatctggatcacccccgttacagcccagctgccccagaccaccgcatatggagatgcctaccatggctactggcagcaggatatatactctctgaacgaaaactacggcactgcagatgacttgaaggcgctctcttcggcccttcatgagagggggatgtatcttatggtcgatgtggttgctaaccatatgggctatgatggaccgggtagctcagtcgattacagtgtgtttgttccgttcaattccgctagctacttccacccgttctgtttcattcaaaactggaatgatcagactcaggttgaggattgctggctaggagataacactgtctccttgcctgatctcgataccaccaaggatgtggtcaagaatgaatggtacgactgggtgggatcattggtatcgaactactccattgacggcctccgtatcgacacagtaaaacacgtccagaaggacttctggcccgggtacaacaaagccgcaggcgtgtactgtatcggcgaggtgctcgacggtgatccggcctacacttgtccctaccaggaagtcctggacggcgtactgaactaccccatttactatccactcctcaacgccttcaagtcaacctccggcagcatggacgacctctacaacatgatcaacaccgtcaaatccgactgtccagactcaacactcctgggcacattcgtcgagaaccacgacaacccacggttcgcttcttacaccaacgacatagccctcgccaagaacgtcgcagcattcatcatcctcaacgacggaatccccatcatctacgccggccaagaacagcactacgccggcggaaacgaccccgcgaaccgcgaagcaacctggctctcgggctacccgaccgacagcgagctgtacaagttaattgcctccgcgaacgcaatccggaactatgccattagcaaagatacaggattcgtgacctacaagaactggcccatctacaaagacgacacaacgatcgccatgcgcaagggcacagatgggtcgcagatcgtgactatcttgtccaacaagggtgcttcgggtgattcgtataccctctccttgagtggtgcgggttacacagccggccagcaattgacggaggtcattggctgcacgaccgtgacggttgattcgtcgggagatgtgcctgttcctatggcgggtgggctacctagggtattgtatccgactgagaagttggcaggtagcaagatctgtagtagctcgggtgctacaagcccgggtggctcctcgggtagtgtcgaggtcactttcgacgtttacgctaccacagtatatggccagaacatctatatcaccggtgatgtgagtgagctcggcaactggacacccgccaatggtgttgcactctcttctgctaactaccccacctggagtgccacgatcgctctccccgctgacacgacaatccagtacaagtatgtcaacattgacggcagcaccgtcatctgggaggatgctatcagcaatcgcgagatcacgacgcccgccagcggcacatacaccgaaaaagacacttgggatgaatcttag

SEQ ID NO: 8 - protein, 586 aa, Aspergillus oryzae
ATPADWRSQSIYFLLTDRFARTDGSTTATCNTADQKYCGGTWQGIIDKLDYIQGMGFTAIWITPVTAQLPQTTAYGDAYHGYWQQDIYSLNENYGTADDLKALSSALHERGMYLMVDVVANHMGYDGPGSSVDYSVFVPFNSASYFHPFCFIQNWNDQTQVEDCWLGDNTVSLPDLDTTKDVVKNEWYDWVGSLVSNYSIDGLRIDTVKHVQKDFWPGYNKAAGVYCIGEVLDGDPAYTCPYQEVLDGVLNYPIYYPLLNAFKSTSGSMDDLYNMINTVKSDCPDSTLLGTFVENHDNPRFASYTNDIALAKNVAAFIILNDGIPIIYAGQEQHYAGGNDPANREATWLSGYPTDSELYKLIASANAIRNYAISKDTGFVTYKNWPIYKDDTTIAMRKGTDGSQIVTILSNKGASGDSYTLSLSGAGYTAGQQLTEVIGCTTVTVDSSGDVPVPMAGGLPRVLYPTEKLAGSKICSSSGATSPGGSSGSVEVTFDVYATTVYGQNIYITGDVSELGNWTPANGVALSSANYPTWSATIALPADTTIQYKYVNIDGSTVIWEDAISNREITTPASGTYTEKDTWDES

SEQ ID NO: 9 - DNA, 1434 bp, Aspergillus oryzae
  CDS (1)..(1434)
gcaacgcctgcggactggcgatcgcaatccatttatttccttctcacggatcgatttgcaaggacggatgggtcgacgactgcgacttgtaatactgcggatcagaaatactgtggtggaacatggcagggcatcatcgacaagttggactatatccagggaatgggcttcacagccatctggatcacccccgttacagcccagctgccccagaccaccgcatatggagatgcctaccatggctactggcagcaggatatatactctctgaacgaaaactacggcactgcagatgacttgaaggcgctctcttcggcccttcatgagagggggatgtatcttatggtcgatgtggttgctaaccatatgggctatgatggaccgggtagctcagtcgattacagtgtgtttgttccgttcaattccgctagctacttccacccgttctgtttcattcaaaactggaatgatcagactcaggttgaggattgctggctaggagataacactgtctccttgcctgatctcgataccaccaaggatgtggtcaagaatgaatggtacgactgggtgggatcattggtatcgaactactccattgacggcctccgtatcgacacagtaaaacacgtccagaaggacttctggcccgggtacaacaaagccgcaggcgtgtactgtatcggcgaggtgctcgacggtgatccggcctacacttgtccctaccaggaagtcctggacggcgtactgaactaccccatttactatccactcctcaacgccttcaagtcaacctccggcagcatggacgacctctacaacatgatcaacaccgtcaaatccgactgtccagactcaacactcctgggcacattcgtcgagaaccacgacaacccacggttcgcttcttacaccaacgacatagccctcgccaagaacgtcgcagcattcatcatcctcaacgacggaatccccatcatctacgccggccaagaacagcactacgccggcggaaacgaccccgcgaaccgcgaagcaacctggctctcgggctacccgaccgacagcgagctgtacaagttaattgcctccgcgaacgcaatccggaactatgccattagcaaagatacaggattcgtgacctacaagaactggcccatctacaaagacgacacaacgatcgccatgcgcaagggcacagatgggtcgcagatcgtgactatcttgtccaacaagggtgcttcgggtgattcgtataccctctccttgagtggtgcgggttacacagccggccagcaattgacggaggtcattggctgcacgaccgtgacggttgattcgtcgggagatgtgcctgttcctatggcgggtgggctacctagggtattgtatccgactgagaagttggcaggtagcaagatctgtagtagctcg

SEQ ID NO: 10 - protein, 478 aa, Aspergillus oryzae
ATPADWRSQSIYFLLTDRFARTDGSTTATCNTADQKYCGGTWQGIIDKLDYIQGMGFTAIWITPVTAQLPQTTAYGDAYHGYWQQDIYSLNENYGTADDLKALSSALHERGMYLMVDVVANHMGYDGPGSSVDYSVFVPFNSASYFHPFCFIQNWNDQTQVEDCWLGDNTVSLPDLDTTKDVVKNEWYDWVGSLVSNYSIDGLRIDTVKHVQKDFWPGYNKAAGVYCIGEVLDGDPAYTCPYQEVLDGVLNYPIYYPLLNAFKSTSGSMDDLYNMINTVKSDCPDSTLLGTFVENHDNPRFASYTNDIALAKNVAAFIILNDGIPIIYAGQEQHYAGGNDPANREATWLSGYPTDSELYKLIASANAIRNYAISKDTGFVTYKNWPIYKDDTTIAMRKGTDGSQIVTILSNKGASGDSYTLSLSGAGYTAGQQLTEVIGCTTVTVDSSGDVPVPMAGGLPRVLYPTEKLAGSKICSSS

SEQ ID NO: 11 - DNA, 1434 bp, Aspergillus oryzae
  CDS (1)..(1434)
gcaacgcctgcggactggcgatcgcaatccatttatttccttctcacggatcgatttgcaaggacggatgggtcgacgactgcgacttgtaatactgcggatcagaaatactgtggtggaacatggcagggcatcatcgacaagttggactatatccagggaatgggcttcacagccatctggatcacccccgttacagcccagctgccccagaccaccgcatatggagatgcctaccatggctactggcagcaggatatatactctctgaacgaaaactacggcactgcagatgacttgaaggcgctctcttcggcccttcatgagagggggatgtatcttatggtcgatgtggttgctaaccatatgggctatgatggaccgggtagctcagtcgattacagtgtgtttgttccgttcaattccgctagctacttccacccgttctgtttcattcaaaactgggataatcagactcaggttgaggattgctggctaggagataacactgtctccttgcctgatctcgataccaccaaggatgtggtcaagaatgaatggtacgactgggtgggatcattggtatcgaactactccattgacggcctccgtatcgacacagtaaaacacgtccagaaggacttctggcccgggtacaacaaagccgcaggcgtgtactgtatcggcgaggtgctcgacggtgatccggcctacacttgtccctaccaggaagtcctggacggcgtactgaactaccccatttactatccactcctcaacgccttcaagtcaacctccggcagcatggacgacctctacaacatgatcaacaccgtcaaatccgactgtccagactcaacactcctgggcacattcgtcgagaaccacgacaacccacggttcgcttcttacaccaacgacatagccctcgccaagaacgtcgcagcattcatcatcctcaacgacggaatccccatcatctacgccggccaagaacagcactacgccggcggaaacgaccccgcgaaccgcgaagcaacctggctctcgggctacccgaccgacagcgagctgtacaagttaattgcctccgcgaacgcaatccggaactatgccattagcaaagatacaggattcgtgacctacaagaactggcccatctacaaagacgacacaacgatcgccatgcgcaagggcacagatgggtcgcagatcgtgactatcttgtccaacaagggtgcttcgggtgattcgtataccctctccttgagtggtgcgggttacacagccggccagcaattgacggaggtcattggctgcacgaccgtgacggttgattcgtcgggagatgtgcctgttcctatggcgggtgggctacctagggtattgtatccgactgagaagttggcaggtagcaagatctgtagtagctcg

SEQ ID NO: 12 - protein, 478 aa, Aspergillus oryzae
ATPADWRSQSIYFLLTDRFARTDGSTTATCNTADQKYCGGTWQGIIDKLDYIQGMGFTAIWITPVTAQLPQTTAYGDAYHGYWQQDIYSLNENYGTADDLKALSSALHERGMYLMVDVVANHMGYDGPGSSVDYSVFVPFNSASYFHPFCFIQNWDNQTQVEDCWLGDNTVSLPDLDTTKDVVKNEWYDWVGSLVSNYSIDGLRIDTVKHVQKDFWPGYNKAAGVYCIGEVLDGDPAYTCPYQEVLDGVLNYPIYYPLLNAFKSTSGSMDDLYNMINTVKSDCPDSTLLGTFVENHDNPRFASYTNDIALAKNVAAFIILNDGIPIIYAGQEQHYAGGNDPANREATWLSGYPTDSELYKLIASANAIRNYAISKDTGFVTYKNWPIYKDDTTIAMRKGTDGSQIVTILSNKGASGDSYTLSLSGAGYTAGQQLTEVIGCTTVTVDSSGDVPVPMAGGLPRVLYPTEKLAGSKICSSS

SEQ ID NO: 13 - DNA, 1761 bp, Aspergillus oryzae
  CDS (1)..(1761)
gcaacgcctgcggactggcgatcgcaatccatttatttccttctcacggatcgatttgcaaggacggatgggtcgacgactgcgacttgtaatactgcggatcagaaatactgtggtggaacatggcagggcatcatcgacaagttggactatatccagggaatgggcttcacagccatctggatcacccccgttacagcccagctgccccagaccaccgcatatggagatgcctaccatggctactggcagcaggatatatactctctgaacgaaaactacggcactgcagatgacttgaaggcgctctcttcggcccttcatgagagggggatgtatcttatggtcgatgtggttgctaaccatatgggctatgatggaccgggtagctcagtcgattacagtgtgtttgttccgttcaattccgctagctacttccacccgttctgtttcattcaaaactgggataatcagactcaggttgaggattgctggctaggagataacactgtctccttgcctgatctcgataccaccaaggatgtggtcaagaatgaatggtacgactgggtgggatcattggtatcgaactactccattgacggcctccgtatcgacacagtaaaacacgtccagaaggacttctggcccgggtacaacaaagccgcaggcgtgtactgtatcggcgaggtgctcgacggtgatccggcctacacttgtccctaccaggaagtcctggacggcgtactgaactaccccatttactatccactcctcaacgccttcaagtcaacctccggcagcatggacgacctctacaacatgatcaacaccgtcaaatccgactgtccagactcaacactcctgggcacattcgtcgagaaccacgacaacccacggttcgcttcttacaccaacgacatagccctcgccaagaacgtcgcagcattcatcatcctcaacgacggaatccccatcatctacgccggccaagaacagcactacgccggcggaaacgaccccgcgaaccgcgaagcaacctggctctcgggctacccgaccgacagcgagctgtacaagttaattgcctccgcgaacgcaatccggaactatgccattagcaaagatacaggattcgtgacctacaagaactggcccatctacaaagacgacacaacgatcgccatgcgcaagggcacagatgggtcgcagatcgtgactatcttgtccaacaagggtgcttcgggtgattcgtataccctctccttgagtggtgcgggttacacagccggccagcaattgacggaggtcattggctgcacgaccgtgacggttgattcgtcgggagatgtgcctgttcctatggcgggtgggctacctagggtattgtatccgactgagaagttggcaggtagcaagatctgtagtagctcgggtgctacaagcccgggtggctcctcgggtagtgtcgaggtcactttcgacgtttacgctaccacagtatatggccagaacatctatatcaccggtgatgtgagtgagctcggcaactggacacccgccaatggtgttgcactctcttctgctaactaccccacctggagtgccacgatcgctctccccgctgacacgacaatccagtacaagtatgtcaacattgacggcagcaccgtcatctgggaggatgctatcagcaatcgcgagatcacgacgcccgccagcggcacatacaccgaaaaagacacttgggatgaatcttag

SEQ ID NO: 14 - protein, 586 aa, Aspergillus oryzae
ATPADWRSQSIYFLLTDRFARTDGSTTATCNTADQKYCGGTWQGIIDKLDYIQGMGFTAIWITPVTAQLPQTTAYGDAYHGYWQQDIYSLNENYGTADDLKALSSALHERGMYLMVDVVANHMGYDGPGSSVDYSVFVPFNSASYFHPFCFIQNWDNQTQVEDCWLGDNTVSLPDLDTTKDVVKNEWYDWVGSLVSNYSIDGLRIDTVKHVQKDFWPGYNKAAGVYCIGEVLDGDPAYTCPYQEVLDGVLNYPIYYPLLNAFKSTSGSMDDLYNMINTVKSDCPDSTLLGTFVENHDNPRFASYTNDIALAKNVAAFIILNDGIPIIYAGQEQHYAGGNDPANREATWLSGYPTDSELYKLIASANAIRNYAISKDTGFVTYKNWPIYKDDTTIAMRKGTDGSQIVTILSNKGASGDSYTLSLSGAGYTAGQQLTEVIGCTTVTVDSSGDVPVPMAGGLPRVLYPTEKLAGSKICSSSGATSPGGSSGSVEVTFDVYATTVYGQNIYITGDVSELGNWTPANGVALSSANYPTWSATIALPADTTIQYKYVNIDGSTVIWEDAISNREITTPASGTYTEKDTWDES

(19) United States
(12) Patent Application Publication
(10) Pub. No.: US 2009/0214708 A1
(43) Pub. Date: Aug. 27, 2009

(54) PREPARATION OF DOUGH AND BAKED PRODUCTS

(75) Inventors: Henrik Lundquist, Malmo (SE); Tomoko Matsui, Chiba (JP); Shiro Fukuyama, Chiba (JP)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 12/305,073

(22) PCT Filed: Jun. 20, 2007
(86) PCT No.: PCT/EP2007/056114

§ 371 Date: Dec. 16, 2008

Related U.S. Application Data
(60) Provisional application No. 60/815,909, filed on Jun. 22, 2006.
(60) Provisional application No. 60/818,671, filed on Jul. 5, 2006.

(30) Foreign Application Priority Data
Jun. 22, 2006 (DK) PA 2006 00844
Jun. 30, 2006 (DK) PA 2006 00890

(51) Int. Cl. A21D 8/04

(52) U.S. Cl. 426/49; 426/61

(57) ABSTRACT

The invention relates to a process for preparing dough or a baked product prepared from the dough by incorporating into the dough a polypeptide comprising a carbohydrate binding module (CBM) and an alpha-amylase catalytic domain.

### SEQUENCE LISTING AND DEPOSITED MICROORGANISMS

### Sequence Listing

The present invention comprises a sequence listing.

### Deposit of Biological Material

None.

### FIELD OF THE INVENTION

The invention relates to a process for preparing dough or a baked product prepared from the dough by incorporating into the dough a hybrid polypeptide comprising a carbohydrate binding module (CBM) and an alpha-amylase catalytic domain.

### BACKGROUND OF THE INVENTION

Fungal alpha-amylase is often incorporated into dough in order to increase the volume of the baked product obtained from the dough (WO 01/034784).

CBM-containing polypeptides are known in the art (WO 90/00609, WO 94/24158 and WO 95/16782).

### SUMMARY OF THE INVENTION

The inventors have found that improved volume can be achieved by adding a hybrid polypeptide comprising a carbohydrate binding module and an alpha-amylase catalytic domain to the dough at a much lower level compared to fungal alpha-amylase.

Accordingly, the invention provides a process for preparing a dough or a baked product prepared from the dough which comprises adding to the dough a hybrid polypeptide comprising a carbohydrate binding module and an alpha-amylase catalytic domain, optionally linked by a linker. The invention also provides dough and a pre-mix comprising these ingredients.

### DEFINITIONS

Alpha-amylase catalytic domain: The term “alpha amylase catalytic domain” is defined herein as polypeptide having alpha-amylase activity.

Alpha-amylase catalytic activity: Endohydrolysis of 1,4-alpha-D-glucosidic linkages in polysaccharides containing three or more 1,4-alpha-linked D-glucose units.

Carbohydrate-binding module (CBM): A polypeptide amino acid sequence which binds preferentially to a poly- or oligosaccharide (carbohydrate).

Hybrid polypeptide: The terms “hybrid enzyme”, “hybrid polypeptide” or just “hybrid” is used herein to characterize the polypeptides used in the invention comprising a first amino acid sequence comprising at least one catalytic module having alpha-amylase activity and a second amino acid sequence comprising at least one carbohydrate-binding module wherein the first and the second are derived from different sources. The term “source” being understood as, e.g., but not limited to, a parent enzyme, e.g., an amylase or glucoamylase, or other catalytic activity comprising a suitable catalytic domain and/or a suitable CBM and/or a suitable linker.

Identity: The relativity between two amino acid sequences or between two nucleotide sequences is described by the parameter “identity”.

For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

The degree of identity between an amino acid sequence of the present invention (“invention sequence”; e.g. amino acids 1 to 478 of SEQ ID NO:2) and a different amino acid sequence (“foreign sequence”) is calculated as the number of exact matches in an alignment of the two sequences, divided by the length of the “invention sequence” or the length of the “foreign sequence”, whichever is the shortest. The result is expressed in percent identity.

An exact match occurs when the “invention sequence” and the “foreign sequence” have identical amino acid residues in the same positions of the overlap (in the alignment example below this is represented by “|”). The length of a sequence is the number of amino acid residues in the sequence (e.g. the length of SEQ ID NO: 2 is 478).

In the alignment example below, the overlap is the amino acid sequence “HTWGERNL” of Sequence 1; or the amino acid sequence “HGWGEDANL” of Sequence 2. In the example a gap is indicated by a “-”.

### Hypothetical Alignment Example:

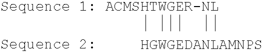

Coding sequence: When used herein the term “coding sequence” means a nucleotide sequence, which directly specifies the amino acid sequence of its protein product.

Expression: The term “expression” includes any step involved in the production of the polypeptide.

cDNA: The term “cDNA” is defined herein as a DNA molecule which lacks intron sequence. The cDNA can be prepared by reverse transcription from a mature, spliced, mRNA molecule obtained from a eukaryotic cell.

Nucleic acid construct: The term “nucleic acid construct” as used herein refers to a nucleic acid molecule, either single- or double-stranded, which is isolated from a naturally occurring gene or which is modified to contain segments of nucleic acids in a manner that would not otherwise exist in nature. The term nucleic acid construct is synonymous with the term “expression cassette” when the nucleic acid construct contains the control sequences required for expression of a coding sequence of the present invention.

Expression vector: The term “expression vector” is defined herein as a linear or circular DNA molecule that comprises a polynucleotide encoding a polypeptide of the invention, and which is operably linked to additional nucleotides that provide for its expression.

Host cell: The term “host cell”, as used herein, includes any cell type which is susceptible to transformation, transfection, transduction, and the like with a nucleic acid construct comprising a polynucleotide of the present invention.

Mutation: The term “mutation” is defined herein as being a deletion, insertion or substitution of an amino acid in an amino acid sequence.

Nomenclature for variants: The nomenclature used for describing variants of the present invention is the same as the nomenclature used in WO 92/05249, i.e. the conventional one-letter codes for amino acid residues are used, and alpha-amylase variants of the invention are described by use of the following nomenclature:

Original amino acid(s): position(s): substituted amino acid(s)

According to this nomenclature, for instance the substitution of aspartic acid for asparagine in position 183 is shown as D183N, whereas a deletion of aspartic acid in the same position is shown as D183*.

### DETAILED DESCRIPTION OF THE INVENTION

### Polypeptide Used in the Invention

The hybrid polypeptide of the present invention comprises a carbohydrate binding module (CBM) and an alpha-amylase catalytic and may optionally further comprise a linker.

The alpha-amylase catalytic domain has at least 60% identity to the amino acid sequence of SEQ ID NO: 2, such as at least 70%, 80% or 90% identity to the amino acid sequence of SEQ ID NO: 2, more preferred at least 91%, such as 92%, 93% or 94% identity to the amino acid sequence of SEQ ID NO: 2, most preferred at least 95%, 96%, 97%, 98% or 99% (hereinafter “homologous polypeptides”). In yet another aspect the alpha-amylase catalytic domain has 100% identity to (i.e. identical to) the amino acid sequence of SEQ ID NO: 2.

In another embodiment the alpha-amylase catalytic domain is a polypeptide derived from SEQ ID NO:2 by substitution, deletion or addition of one or more amino acids. In a particularly preferred aspect of the alpha-amylase catalytic domain the total number of amino acid mutations of amino acids 1-478 of SEQ ID NO: 2 is not more than 20, such as 19 or 18 or 17 or 16, even less than 15, such as 14 or 13 or 12 or 11 or 10, preferably 9, more preferably 8, more preferably 7, more preferably at most 6, more preferably at most 5, more preferably 4, even more preferably 3, most preferably 2, and even most preferably 1 or 0. In a most preferred embodiment the alpha-amylase catalytic domain is comprises the amino acids 1 to 478 of SEQ ID NO:10 or comprises the amino acids 1 to 478 of SEQ ID NO: 12, or is identical to the amino acids 1 to 478 of SEQ ID NO:10, or is identical to the amino acids 1 to 478 of SEQ ID NO:12.

In a yet another aspect, the present invention relates to isolated polypeptides having alpha-amylase activity which are encoded by polynucleotides which hybridize under very low stringency conditions, preferably low stringency conditions, more preferably medium stringency conditions, more preferably medium-high stringency conditions, even more preferably high stringency conditions, and most preferably very high stringency conditions with (i) nucleotides 1-1434 of SEQ ID NO: 1, (ii) the cDNA sequence contained in nucleotides 1-1434 of SEQ ID NO: 1, (iii) a subsequence of (i) or (ii), or (iv) a complementary strand of (i), (ii), or (iii) (J. Sambrook, E. F. Fritsch, and T. Maniatus, 1989, Molecular Cloning, A Laboratory Manual, 2d edition, Cold Spring Harbor, N.Y.). A subsequence of SEQ ID NO: 1 contains at least 100 contiguous nucleotides or preferably at least 200 contiguous nucleotides. Moreover, the subsequence may encode a polypeptide fragment which has alpha-amylase activity.

For long probes of at least 100 nucleotides in length, very low to very high stringency conditions are defined as prehybridization and hybridization at 42° C. in 5×SSPE, 0.3% SDS, 200 ug/ml sheared and denatured salmon sperm DNA, and either 25% formamide for very low and low stringencies, 35% formamide for medium and medium-high stringencies, or 50% formamide for high and very high stringencies, following standard Southern blotting procedures for 12 to 24 hours optimally.

For long probes of at least 100 nucleotides in length, the carrier material is finally washed three times each for 15 minutes using 2×SSC, 0.2% SDS preferably at least at 45° C. (very low stringency), more preferably at least at 50° C. (low stringency), more preferably at least at 55° C. (medium stringency), more preferably at least at 60° C. (medium-high stringency), even more preferably at least at 65° C. (high stringency), and most preferably at least at 70° C. (very high stringency).

Under salt-containing hybridization conditions, the effective Tm is what controls the degree of identity required between the probe and the filter bound DNA for successful hybridization. The effective Tm may be determined using the formula below to determine the degree of identity required for two DNAs to hybridize under various stringency conditions.

Effective Tm=81.5+16.6(log M[Na+])+0.41(% G+C)−0.72(% formamide)

A 1% mismatch of two DNAs lowers the Tm by 1.4° C. To determine the degree of identity required for two DNAs to hybridize under medium stringency conditions at 42° C., the following formula is used:

% Homology=100−[(Effective Tm−Hybridization Temperature)/1.4]

Carbohydrate binding modules suitable for use in the context of the present invention are CBMs from alpha-amylase, maltogenic alpha-amylases, cellulases, xylanases, mannanases, arabinofuranosidases, acetylesterases and chitinases. Further CBMs of interest in relation to the present invention include CBMs deriving from glucoamylases (EC 3.2.1.3) or from CGTases (EC 2.4.1.19).

CBMs deriving from fungal, bacterial or plant sources will generally be suitable for use in the hybrid of the invention. Preferred are CBMs of fungal origin. In this connection, techniques suitable for isolating the relevant genes are well known in the art.

Preferably the hybrid comprises a CBM which is derived from any family or species selected from the group consisting of Acremonium, Aspergillus, Athelia, Coniochaeta, Cryptosporiopsis, Dichotomocladium, Dinemasporium, Diplodia, Gliocladium, Leucopaxillus, Malbranchea, Meripilus, Nectria, Pachykytospora, Penicillium, Rhizomucor, Rhizomucor pusillus, Streptomyces, Subulispora, Thermomyces, Trametes, Trichophaea saccata and Valsaria. The CBM may also be derived from a plant, e.g., from corn (e.g., Zea mays) or a bacterial, e.g., Bacillus. More preferably the hybrid comprises a CBM derived from any species selected from the group consisting of Acremonium sp., Aspergillus kawachii, Aspergillus niger, Aspergillus oryzae, Athelia rolfsii, Bacillus flavothermus, Coniochaeta sp., Cryptosporiopsis sp., Dichotomocladium hesseltinei, Dinemasporium sp., Diplodia sp., Gliocladium sp., Leucopaxillus gigantus, Malbranchea sp., Meripilus giganteus, Nectria sp., Pachykytospora papayracea, Penicillium sp., Rhizomucor pusillus, Streptomyces thermocyaneoviolaceus, Streptomyces limosus, Subulispora provurvata, Thermomyces lanuginosus, Trametes cingulata, Trametes corrugata, Trichophaea saccata, Valsaria rubricosa, Valsario spartii and Zea mays.

Most preferably the polypeptide used in the invention comprises a CBM from glucoamylase from Athelia rolfsii (SEQ ID NO: 4).

In another embodiment the CBM is a polypeptide derived from SEQ ID NO:4 by substitution, deletion or addition of one or more amino acids. In a particularly preferred embodiment the polypeptide used in the invention comprises a CBM sequence which differs from an amino acid sequence of SEQ ID NO: 4 in no more than 10 positions, no more than 9 positions, no more than 8 positions, no more than 7 positions, no more than 6 positions, no more than 5 positions, no more than 4 positions, no more than 3 positions, no more than 2 positions, or even no more than 1 position.

Also preferred are any CBM encoded by a DNA sequence having at least 60%, at least 65%, at least 70%, at least 75%, at least 80%, at least 85%, at least 90% or even at least 95% homology to the sequence of SEQ ID NO: 3. Further preferred is any CBM encoded by a DNA sequence hybridizing under high, medium or low stringency with (i) nucleotides 1 to 294 of SEQ ID NO: 3, (ii) the cDNA sequence contained in nucleotides 1 to 294 of SEQ ID NO: 3, (iii) a subsequence of (i) or (ii), or (iv) a complementary strand of (i), (ii), or (iii) (J. Sambrook, E. F. Fritsch, and T. Maniatus, 1989, Molecular Cloning, A Laboratory Manual, 2d edition, Cold Spring Harbor, N.Y.). A subsequence of SEQ ID NO: 3 contains at least 100 contiguous nucleotides or preferably at least 200 contiguous nucleotides.

CBM-containing polypeptides, as well as detailed descriptions of the preparation and purification thereof, are known in the art [see, e.g., WO 90/00609, WO 94/24158 and WO 95/16782, as well as Greenwood et al. in Biotechnology and Bioengineering 44 (1994) pp. 1295-1305]. They may, e.g., be prepared by transforming into a host cell a DNA construct comprising at least a fragment of DNA encoding the carbohydrate-binding module ligated, with or without a linker, to a DNA sequence encoding the polypeptide of interest, and growing the transformed host cell to express the fused gene. The CBM in a polypeptide used in the invention may be positioned C-terminally, N-terminally or internally in polypeptide. In an embodiment a polypeptide used in the invention may comprise more than one CBM, e.g., two CBMs; one positioned C-terminally, the other N-terminally or the two CBMs in tandem positioned C-terminally, N-terminally or internally. However, polypeptides with more than two CBMs are equally contemplated.

The linker may be a bond (i.e. comprising 0 residues), or a short linking group comprising from about 2 to about 100 carbon atoms, in particular of from 2 to 40 carbon atoms. However, the linker is preferably a sequence of 0 amino acid residues or it is from about 2 to about 100 amino acid residues, more preferably of from 2 to 40 amino acid residues, such as from 2 to 15 amino acid residues. Preferably the linker is not sensitive to or at least has low sensitivity towards hydrolysis by a protease, which e.g., may be present during production of the polypeptide and/or during the industrial application of the polypeptide.

Most preferably the polypeptide used in the invention comprises a linker from glucoamylase from Athelia rolfsii (SEQ ID NO:6).

In another embodiment the linker is a polypeptide derived from SEQ ID NO:6 by substitution, deletion or addition of one or more amino acids. In a particularly preferred embodiment the polypeptide used in the invention comprises a linker sequence which differs from an amino acid sequence of SEQ ID NO: 6 in no more than 10 positions, no more than 9 positions, no more than 8 positions, no more than 7 positions, no more than 6 positions, no more than 5 positions, no more than 4 positions, no more than 3 positions, no more than 2 positions, or even no more than 1 position.

Also preferred are any linkers encoded by a DNA sequence having at least 60%, at least 65%, at least 70%, at least 75%, at least 80%, at least 85%, at least 90% or even at least 95% homology to the sequence of SEQ ID NO: 5. Further preferred is any linker encoded by a DNA sequence hybridizing under high, medium or low stringency to the DNA sequence of SEQ ID NO: 5.

The hybrid polypeptide has in a particular embodiment at least 70% identity to the amino acids 1 to 586 of SEQ ID NO:8 or of SEQ ID NO:14, such as at least 80%, 85% or 90% identity to the amino acids 1 to 586 of SEQ ID NO:8 or of SEQ ID NO:14, even more preferably at least 95%, such as 96%, 97%, 98% or 99% identity to the amino acids 1 to 586 of SEQ ID NO:8 or of SEQ ID NO:14. In a most preferred embodiment the hybrid polypeptide for use in baking may be identical to the amino acids 1 to 586 of SEQ ID NO:8 or of SEQ ID NO:14.

In another aspect the hybrid polypeptide is encoded by a polynucleotide which under at least medium stringency conditions, such as high stringency conditions or even very high stringency conditions, hybridizes with (i) nucleotides 1 to 1760 of SEQ ID NO: 7 or of SEQ ID NO:13, (ii) the cDNA sequence contained in nucleotides 1 to 1760 of SEQ ID NO: 7 or of SEQ ID NO:13, or (iii) a complementary strand of (i) or (ii).

In yet another aspect the hybrid polypeptide is derived from SEQ ID NO:8 or of SEQ ID NO:14 by substitution, deletion or addition of one or more amino acids.

### Baking

The polypeptide used in the present invention is added in an effective amount for improving the baked product, in particular the volume. The amount of polypeptide will typically be in the range of 0.01-10 mg of enzyme protein per kg of flour, e.g. 0.1-5 mg/kg of flour, such as 0.2-4 mg/kg of flour.

### Dough

The dough of the invention generally comprises wheat meal or wheat flour and/or other types of meal, flour or starch such as corn flour, corn starch, rye meal, rye flour, oat flour, oat meal, soy flour, sorghum meal, sorghum flour, potato meal, potato flour or potato starch.

The dough of the invention may be fresh, frozen or par-baked.

The dough of the invention is normally a leavened dough or a dough to be subjected to leavening. The dough may be leavened in various ways, such as by adding chemical leavening agents, e.g., sodium bicarbonate or by adding a leaven (fermenting dough), but it is preferred to leaven the dough by adding a suitable yeast culture, such as a culture of Saccharomyces cerevisiae (baker's yeast), e.g. a commercially available strain of S. cerevisiae.

The dough may also comprise other conventional dough ingredients, e.g.: proteins, such as milk powder, gluten, and soy; eggs (either whole eggs, egg yolks or egg whites); an oxidant such as ascorbic acid, potassium bromate, potassium iodate, azodicarbonamide (ADA) or ammonium persulfate; an amino acid such as L-cysteine; a sugar; a salt such as sodium chloride, calcium acetate, sodium sulfate or calcium sulfate.

The dough may comprise fat (triglyceride) such as granulated fat or shortening, but the invention is particularly applicable to a dough where less than 1% by weight of fat (triglyceride) is added, and particularly to a dough which is made without addition of fat.

The dough may further comprise an emulsifier such as mono- or diglycerides, diacetyl tartaric acid esters of mono- or diglycerides, sugar esters of fatty acids, polyglycerol esters of fatty acids, lactic acid esters of monoglycerides, acetic acid esters of monoglycerides, polyoxyethylene stearates, or lysolecithin.

### Additional Enzyme

Optionally, an additional enzyme may be used together with the polypeptide comprising a carbohydrate binding module and an alpha-amylase. The additional enzyme may be an amylase, such as an a maltogenic amylase, amyloglucosidase, a beta-amylase, a cyclodextrin glucanotransferase, or the additional enzyme may be a peptidase, in particular an exopeptidase, a transglutaminase, a lipolytic enzyme, a cellulase, a hemicellulase, in particular a pentosanase such as xylanase, a protease, a protein disulfide isomerase, e.g., a protein disulfide isomerase as disclosed in WO 95/00636, a glycosyltransferase, a branching enzyme (1,4-alpha-glucan branching enzyme), a 4-alpha-glucanotransferase (dextrin glycosyltransferase) or an oxidoreductase, e.g., a peroxidase, a laccase, a glucose oxidase, a pyranose oxidase, a lipoxygenase, an L-amino acid oxidase or a carbohydrate oxidase.

The additional enzyme may be of any origin, including mammalian and plant, and preferably of microbial (bacterial, yeast or fungal) origin and may be obtained by techniques conventionally used in the art.

The maltogenic amylase may be derived from Bacillus stearothermiphilus as described in EP 494233 or a variant thereof as described in WO 99/43794.

The lipolytic enzyme may have lipase activity (EC 3.1.1.3), phospholipase A1 activity, phospholipase A2 activity and/or galactolipase activity.

### Baked Product

The process of the invention may be used for any kind of baked product prepared from dough, either of a soft or a crisp character, either of a white, light or dark type. Examples are bread (in particular white, whole-meal or rye bread), typically in the form of loaves or rolls, French baguette-type bread, pita bread, tortillas, cakes, pancakes, biscuits, cookies, pie crusts, crisp bread, steamed bread, pizza and the like.

### Pre-Mix

The present invention further relates to a pre-mix comprising flour together with a polypeptide comprising a carbohydrate binding module and an alpha-amylase. The pre-mix may contain other dough-improving and/or bread-improving additives, e.g. any of the additives, including enzymes, mentioned above.

### Polypeptide Preparation

The invention provides a polypeptide preparation comprising a polypeptide comprising a carbohydrate binding module and an alpha-amylase, for use as a baking additive in the process of the invention. The hybrid polypeptide preparation is preferably in the form of a granulate or agglomerated powder. It preferably has a narrow particle size distribution with more than 95% (by weight) of the particles in the range from 25 to 500 micro-m.

Granulates and agglomerated powders may be prepared by conventional methods, e.g. by spraying the amylase onto a carrier in a fluid-bed granulator. The carrier may consist of particulate cores having a suitable particle size. The carrier may be soluble or insoluble, e.g. a salt (such as NaCl or sodium sulfate), a sugar (such as sucrose or lactose), a sugar alcohol (such as sorbitol), starch, rice, corn grits, or soy.

Alternatively the hybrid polypeptide preparation is in a liquid form, e.g. dissolved in a sugar alcohol (such as sorbitol).

### EXAMPLES

### Example 1

### Baking with a Hybrid Polypeptide

Bread was baked according to the straight dough method.

### Process Flow Straight Dough Procedure:

### Recipe

| | |
|---|---|
| Dough | % on flour basis |
| Ascorbic acid | 50 ppm (to be optimized for each flour) |
| Yeast | 4 |
| Salt | 1.5 |
| Water | 61 (to be optimized for each flour) |
| Wheat flour + | 100 (Pelikaan from Meneba) |
| enzymes | |

### Enzymes

The following polypeptides have been applied in this experiment:

| | |
|---|---|
| Fungamyl | SEQ ID NO: 2 |
| Fungamyl variant II | SEQ ID NO: 12 |
| Hybrid polypeptide II | SEQ ID NO: 14 |

### Procedure

1. Scaling of ingredients, addition of yeast, ascorbic acid and enzymes
2. Temperature adjustment, scaling and addition of water into mixer bowl
3. Addition of flour into mixer bowl
4. Mixing: 3 min at setting 1 and 7 minutes at setting 2 using a Diosna spiral mixer.
5. The dough is taken from the mixer bowl and the temperature is determined, the dough parameters are determined (dough evaluation after mixing) and the dough is molded on the molder.
6. The dough is given 20 minutes bench-time under plastic cover and the second dough evaluation is performed (dough parameters after bench-time)
7. The dough is scaled for roll maker plate (1500 g/30 rolls) and bread (350 g/bread) and molding there after.
8. The molded dough is given 15 minutes bench time covered in plastic
9. The dough for rolls is formed to an approximately 34 cm round plate and put on a roll maker plate and rolls are formed in a rounder. The rolls are transferred to a silicone covered baking sheet.
   The dough for bread are shaped in a sheeter and transferred to pans which are put in baking sheet.
10. The bread and rolls are proofed at 32° C., 86% rh.
   The proofing time for rolls is 45 minutes.
   The proofing time for bread is 55 minutes.
11. The bread is baked at 230° C. with steam.
   The rolls are baked for 22 minutes (damper opens after 12 minutes in order to let out the steam from the oven).
   The bread is baked for 35 minutes (damper opens after 25 minutes in order to let out the steam from the oven).
12. The bread is taken out of the pans after baking and put on a baking sheet.
13. The bread and rolls are allowed to cool down.
14. The bread and rolls are evaluated with respect to volume.

Enzymes were dosed according to Table 1 below:

TABLE 1
Enzyme dosages

| | 1 | 2 | 3 | 4 | 5 |
|---|---|---|---|---|---|
| Fungamyl | | 0.5 | 1.5 | | |
| (mg/kg flour) | | | | | |
| Hybrid polypeptide II | | | | 0.3 | |
| (mg/kg flour) | | | | | |
| Fungamyl variant II | | | | | 0.3 |
| (mg/kg flour) | | | | | |

The volume of rolls and bread was determined through standard rape seed displacement method.

Changes in volume of less than 5% are not considered to be significant.

The specific volume index was calculated according Equation 1:

Specific volume index=Specific volume of Bread with enzyme(ml/g)/Specific volume of Bread without enzyme(ml/g)*100%

The average specific volume of three control doughs was set to 100%.

The specific volumes of the enzyme treated bread are average of double samples.

### Results:

The effect of the different enzymes on roll and bread volume can be seen in Table 2:

TABLE 2
Specific volume index [%] with enzyme treatment rolls and bread

| | Rolls | Bread |
|---|---|---|
| No enzyme | 100 | 100 |
| Hybrid polypeptide II | 106 | 107 |
| [0.3 mg/kg flour] | | |
| Fungamyl variant II | 101 | 104 |
| [0.3 mg/kg flour] | | |
| Fungamyl | 99 | 103 |
| [0.5 mg/kg flour] | | |
| Fungamyl | 103 | 107 |
| [1.5 mg/kg flour] | | |

The effect of the hybrid polypeptide is clearly illustrated:

A dosage of 0.3 mg protein enzyme/kg flour of the hybrid polypeptide 11 (SEQ ID NO:14) gives a significant volume increase for both rolls and bread.

The Fungamyl variant does not give a significant volume increase when it is dosed at 0.3 mg protein enzyme/kg flour.

For Fungamyl a dosage of 0.5 mg protein enzyme/kg flour does not give a significant volume. A dosage of 1.5 mg Fungamyl protein enzyme/kg flour is needed to obtain a significant volume increase.

The improved performance of the hybrid polypeptide II (SEQ ID NO:14) may be due to the presence of a CBM since neither Fungamyl or the Fungamyl variant II (SEQ ID NO: 12) is able to give a significant volume increase at low dosages of 0.3-0.5 mg protein enzyme/kg flour.

1. A process for preparing a dough or a baked product prepared from the dough, comprising incorporating into the dough a hybrid polypeptide comprising:
(a) a first amino acid sequence comprising an alpha-amylase catalytic domain which
i. has at least 70% identity to the amino acids 1 to 478 of SEQ ID NO: 2, or
ii. is encoded by a polynucleotide which hybridizes under at least medium stringency conditions with (i) nucleotides 1 to 1434 of SEQ ID NO: 1, (ii) the cDNA sequence contained in nucleotides 1 to 1434 of SEQ ID NO: 1, or (iii) a complementary strand of (i) or (ii); or
iii. is a polypeptide derived from SEQ ID NO: 2 by substitution, deletion or addition of one more amino acid; and
(b) a second amino acid sequence comprising a carbohydrate binding module which
i. has at least 70% identity to the amino acids 1 to 97 of SEQ ID NO: 4, or
ii. is encoded by a polynucleotide which hybridizes under at least medium stringency conditions with (i) nucleotides 1 to 294 of SEQ ID NO: 3, (ii) the cDNA sequence contained in nucleotides 1 to 294 of SEQ ID NO: 3, or (iii) a complementary strand of (i) or (ii);
iii. is a polypeptide derived from SEQ ID NO: 4 by substitution, deletion or addition of one more amino acid; and optionally
(c) a linker comprising 0 to 50 amino acids between the first amino acid sequence and the second amino acid sequence.

2. The process of claim 1 wherein the hybrid polypeptide
i. has at least 70% identity to the amino acids 1 to 586 of SEQ ID NO:8, or
ii. has at least 70% identity to the amino acids 1 to 586 of SEQ ID NO:14, or
iii. is encoded by a polynucleotide which hybridizes under at least medium stringency conditions with (i) nucleotides 1 to 1760 of SEQ ID NO: 7, (ii) the cDNA sequence contained in nucleotides 1 to 1760 of SEQ ID NO: 7, or (iii) a complementary strand of (i) or (ii); or
iv. is encoded by a polynucleotide which hybridizes under at least medium stringency conditions with (i) nucleotides 1 to 1760 of SEQ ID NO: 13, (ii) the cDNA sequence contained in nucleotides 1 to 1760 of SEQ ID NO: 13, or (iii) a complementary strand of (i) or (ii); or
v. is a polypeptide derived from SEQ ID NO: 8 by substitution, deletion or addition of one more amino acids, or
vi. is a polypeptide derived from SEQ ID NO: 14 by substitution, deletion or addition of one more amino acids.

3. The process of claim 1 wherein the first amino acid sequence of the hybrid polypeptide comprises
i. the amino acids 1 to 478 of SEQ ID NO: 10, or
ii. the amino acids 1 to 478 of SEQ ID NO: 12.

4. The process of claim 1 wherein the second amino acid sequence of the hybrid polypeptide is SEQ ID NO: 4.

5. The process of claim 1 wherein the optional linker of the hybrid polypeptide has the amino acid sequence of SEQ ID NO: 6.

6. The process of claim 1 where the hybrid polypeptide is dosed in the range of 0.1-5 mg protein/kg of flour.

7. A baking composition comprising the polypeptide of claim 1 and a baking ingredient.

8. A composition comprising the polypeptide of claim 1 and flour.

9. A composition comprising
a. the polypeptide of claim 1, and
b. one or more components selected from the group consisting of leavening agent, milk powder, gluten emulsifier, granulated fat and an oxidant.

10. The composition of claim 9 which is a dough.
